(19) United States
(12) Patent Application Publication
(10) Pub. No.: US 2016/0263472 A1
(43) Pub. Date: Sep. 15, 2016

(54) ENHANCED ROULETTE GAME

(71) Applicant: JESSE JORGE CHAVEZ-MUNOZ, BOURNEMOUTH (GB)

(72) Inventor: JESSE JORGE CHAVEZ-MUNOZ, BOURNEMOUTH (GB)

(21) Appl. No.: 14/972,124

(22) Filed: Dec. 17, 2015

(30) Foreign Application Priority Data
Mar. 14, 2015 (GB) 1504338.3

(51) Int. Cl. A63F 5/00; G07F 17/32

(52) U.S. Cl. CPC A63F 5/0005; A63F 5/00; G07F 17/3213

(57) ABSTRACT

Disclosed is an enhanced roulette game. The invention adds new wagering options for betting on a live roulette game using a conventional roulette wheel and playing surface and for betting on virtual or electronic representations of a roulette game. In this invention the numerical sequence on the roulette wheel is divided into four non-equal sections, each section containing a set sequence of numbers corresponding to numbers marked on the roulette layout and allowing for one additional ten (10) chip “straight up” and “split” bet; one additional eleven (11) chip “straight up” bet; and one additional eleven (11) chip “straight up” and “split” bet. The invention introduces a new element to roulette games with musical notes triggered by winning numbers.

### CROSS REFERENCE TO RELATED APPLICATIONS

Not Applicable

STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

The game of roulette is a well established casino game recognised by many people throughout the world. The origins of the game have been variously credited to Blaise Pascal, a 17th Century French mathematician, to Dominican monks introducing the game from China, and to an amalgamation of other European games. The present form of roulette has been played at casinos since the late 18th Century.

The game involves a wheel divided into segments, traditionally including 36 segments, numbered 1 to 36, which are divided into two distinct colours (traditionally red and black). One or two additional segments, numbered ‘0’ and ‘00’ also appear on the wheel. The additional segments are coloured a different colour (traditionally green).

Players place wagers on possible game outcomes on a wagering layout and a variety of betting options are normally provided (for example red/black, even/odd, etc.). By spinning the wheel and dropping a ball onto the wheel the game outcome is defined by the segment in which the ball comes to rest.

Call or announced bets, first introduced for the much larger French roulette gaming tables, are when the dealer places the gaming pieces, known as chips, on the table layout for a player. Call bets are still permitted at many casinos.

Roulette remains popular in its traditional live manual form and in modern adaptations such as a simulated or virtual casino game, an automated casino game and in various electronic and on-line forms. It is an object of the present invention to provide a roulette game that offers additional player features.

It is desirable to maintain and increase the interest of roulette players without detracting from the traditional roulette game. One form of enhancement can be to provide a variation or addition to traditional betting positions on the roulette layout and create further winning opportunities without these being detrimental to operator profitability.

### BRIEF SUMMARY OF THE INVENTION

This invention relates generally to the game of roulette as played in all its forms. The invention enhances both the speed of operation of each game played and the customer service offered to players. It creates added interest for players by providing new wagering possibilities. The invention also creates added interest for players by the ability of a winning number in a roulette game to be further enhanced by a series of musical notes.

### BRIEF DESCRIPTION OF THE SEVERAL VIEWS OF THE DRAWING

FIG. 1—A drawing of a conventional double zero roulette wheel divided into four sections as designated by the invention and as described in the Detailed Description of the Invention.

FIG. 2—A drawing of a conventional double zero roulette layout showing the placing of gaming chips for the numbers listed for Section A of the gaming wheel as described in the Detailed Description of the Invention.

FIG. 3—A drawing of a conventional double zero roulette layout showing the placing of gaming chips for the numbers listed for Section B of the gaming wheel as described in the Detailed Description of the Invention.

FIG. 4—A drawing of a conventional double zero roulette layout showing the placing of gaming chips for the numbers listed for Section C of the gaming wheel as described in the Detailed Description of the Invention.

### DETAILED DESCRIPTION OF THE INVENTION

This invention relates generally to the game of roulette as played in all its forms. The invention is directed to wagering on roulette games typically found in gaming establishments, such as those involving a roulette wheel with or without a number reader, a playing surface, multiple wagering positions and a dealer, or virtual representations thereof.

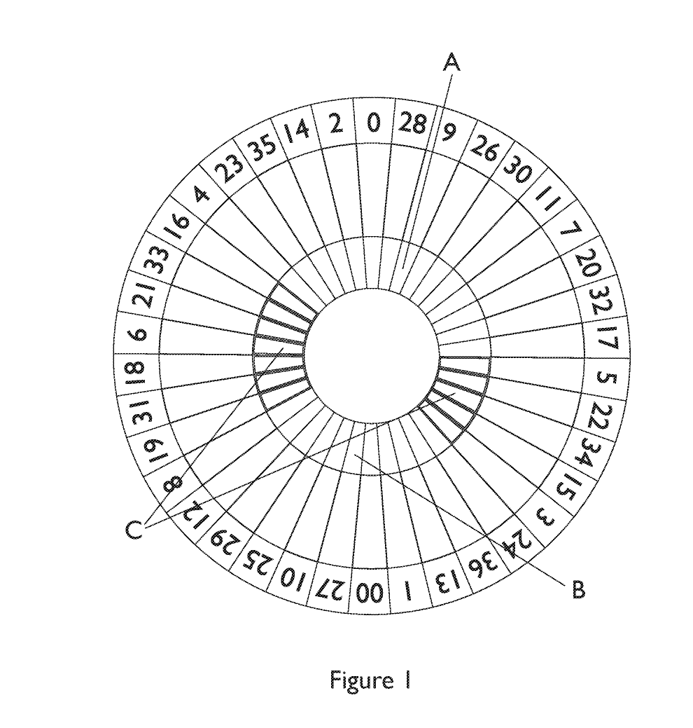

In this invention the numbers on the roulette wheel are divided into four sections (FIG. 1) with sections A and B divided by split sections C. These sections of the wheel may be modified and coloured to improve visual impact but this is not a requirement of the invention. In this invention the wheel number sequence is divided into the three named sections.

In this invention the roulette layout or playing surface or the screen in virtual and or electronic roulette games remains that of conventional roulette layouts, playing surfaces or screens, with a plurality of wagering positions.

A double zero roulette wheel has a numerical sequence of: 0-28-9-26-30-11-7-20-32-17-5-22-34-15-3-24-36-13-1-00-27-10-25-29- 12-8-19-31-18-6-21-33-16-4-23-35-14-2 In this invention Section A of the roulette wheel (FIG. 1) contains the numbers 4, 23, 35, 14, 2, 0, 28, 9, 26, 30, 11, 7, 20, 32, 17.

In this invention Section B of the roulette wheel (FIG. 1) contains the numbers 24, 36, 13, 1, 00, 27, 10, 25, 29, 12, 8, 19.

In this invention Section C of the roulette wheel (FIG. 1) is divided into two and contains the numbers 19, 31, 18, 6, 21, 33, 16 and 5, 22, 34, 15, 3.

In conventional roulette a one chip bet of whatever denomination placed on one of the designated betting positions on the layout is rewarded with a set payout in the event of a win. In this invention a 10 or 11 chip bet is placed on the layout in the designated pattern of numbers and a win is created when the roulette ball falls into one of the numbers covered in the designated pattern.

Section A of the numerical sequence on the roulette wheel allows for an additional 10-piece (10 chips) bet to be placed on the roulette layout. Section B and Sections C of the numerical sequence on the roulette wheel each allow for an additional 11-piece (11 chips) bet to be placed on the roulette layout.

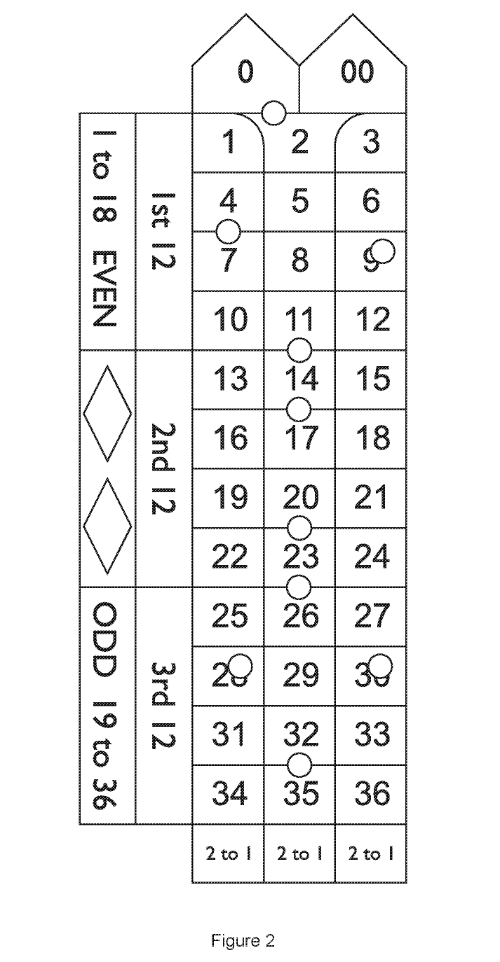

Players may place wagers on these designated number sequences, specified by the relevant named section and as shown in FIG. 2 or FIG. 3 or FIG. 4, in addition or instead of the traditional wagering positions. Players may also hand the dealer the chips or cash to cover the selected 10 or 11 chip wager. The dealer may call or announce the selected named wager without placing the chips individually, thus speeding the rate the game is played.

Bets in roulette games are named to denote the numbers covered by a single bet (chip), such as “Straight-Up” when the bet placed on the betting surface covers only the number and “Split” when the bet placed on the betting surface covers two numbers and is placed on the line separating those two numbers. In this invention split bets are identified by the numbers separated by an oblique sign −/− such as the Split bet 0 and 2, which shall be represented as “0/2”

In this invention the named sections for a double zero “00” roulette wheel cover the following number sequences:

Section A (FIG. 2) 10-piece (10 chips) bet:

Straight-Up bets covering one number. One chip on each number: 9, 28 and 30

Split bets covering two (2) numbers. One chip on each Split: 0/2, 4/7, 11/14, 14/17, 20/23, 23/26, 32/35

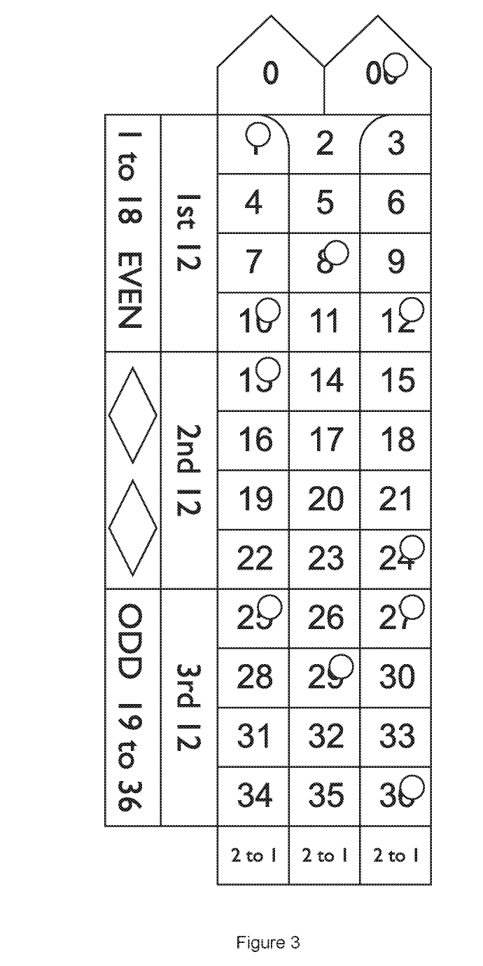

Section B (FIG. 3) 11-piece (11 chips) bet:

Straight-Up bets covering one number. One chip on each number: 00, 1, 8, 10, 12, 13, 24, 25, 27, 29, and 36

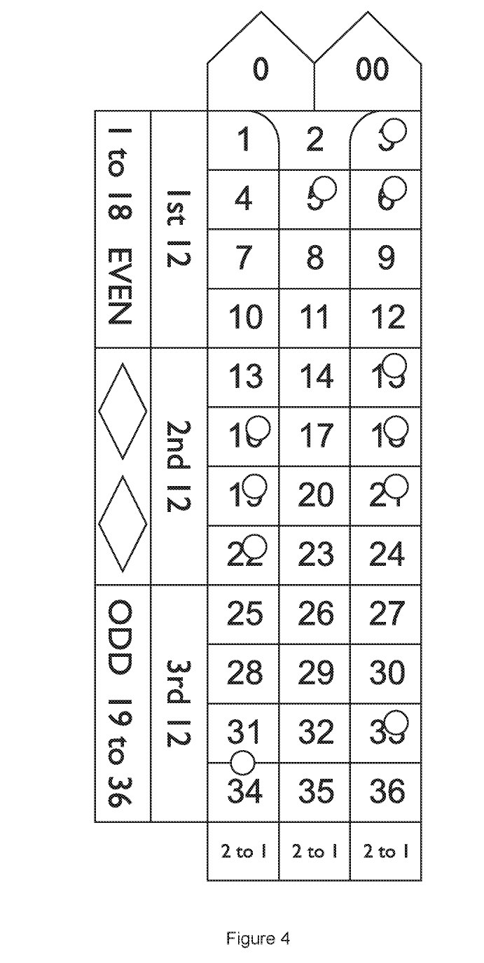

Section C (FIG. 4) 11-piece (11 chips) bet:

Straight-Up bets covering one number. One chip on each number: 3, 5, 6, 15, 16, 18, 19, 21, 22, 33

Split bets covering two (2) numbers. One chip on Split 31/34

In this invention electronic, digital, virtual or interactive roulette games will be modified to show the named sections by additional markings on or outside the roulette layout and the electronic device shall apportion the necessary chips to cover the bet on the section or sections selected.

In the event of a win for the player when the roulette ball falls into a number covered by the player's 10-piece or 11-piece bet the winning bet will be paid according to preset payouts for the roulette game.

In this invention in the event of a win for a player a series of musical notes may be triggered when the roulette ball falls into a number covered by the player's chosen 10-piece or 11-piece bet. Whether activated by an automatic electronic device or added to the game or a special device supported by the game personnel, the addition of an aural enhancement to the game may increase player participation and satisfaction.

The series of musical notes will be different for each named section, A, B or C (FIG. 1).

1. A gaming apparatus comprising a conventional roulette wheel marked or unmarked with two defined number sections divided by a third split number section creating four unequal sections of numerical sequences.

2. A gaming apparatus of a conventional table roulette layout comprising a traditional plurality of betting positions and allowing for additional roulette chip wagers in designated “straight up” and “split” positions on the layout and with corresponding payouts or rewards.

3. The gaming apparatus of claim 1 further comprising an electronic, mechanical or manual means to trigger the playing of musical notes defined by the roulette ball falling into the winning number in a particular section of the roulette wheel.

4. The gaming apparatus of claim 2 comprising a plurality of existing conventional betting positions; and three new betting positions allowing for one 11-piece“straight up” bet; one 11-piece “straight up” and “split” bet; and one 10-piece “straight up” and “split” bet.

5. The gaming apparatus as described in claim 1, claim 2, claim 3 and claim 4 modified for electronic or virtual representations of the enhanced roulette game.
